(19) United States
(12) Patent Application Publication
(10) Pub. No.: US 2015/0069807 A1
(43) Pub. Date: Mar. 12, 2015

(54) DEVICE FOR ELECTRICALLY DRIVING A LONGITUDINAL ADJUSTMENT MECHANISM FOR A VEHICLE SEAT

(71) Applicants: Andreas KAPPEL, (US); Johnson Controls GmbH, Burscheid, (DE)

(72) Inventor: Ingo Kienke, Wermelskirchen (DE)

(73) Assignees: Andreas KAPPEL, Brunnthal, (DE); Johnson Controls GmbH, Burscheid, (DE)

(21) Appl. No.: 14/395,178

(22) PCT Filed: Apr. 19, 2013
(86) PCT No.: PCT/EP2013/058138

§ 371 Date: Oct. 17, 2014

(30) Foreign Application Priority Data
Apr. 20, 2012 (DE) 10 2012 007 760.2
Jul. 11, 2012 (DE) 10 2012 212 142.0

(51) Int. Cl. B60N 2/02; B60N 2/06

(52) U.S. Cl. CPC B60N 2/0232; B60N 2/06; B60N 2002/0236
USPC 297/344.1

(57) ABSTRACT

A device is for electrically driving a longitudinal adjustment mechanism for a vehicle seat, which mechanism includes two individual rails. The device for electrically driving a longitudinal adjustment mechanism for a vehicle seat includes a separate electric driving device for each individual rail. Each of the driving devices is designed as an electromechanically actuated planetary gear assembly.

The invention relates to a device for electrically driving a longitudinal adjustment mechanism for a vehicle seat.

In the prior art, electrically driven longitudinal adjustment mechanisms of a vehicle seat are driven by an individual drive motor which is arranged in a so-called motor bridge between the two individual rails of the longitudinal adjustment mechanism. In this case, the drive shafts distribute the torque of the drive motor between the two individual rails and in each case drive a gear unit which is formed at least from a spindle and a worm gear. Such longitudinal adjustment mechanisms are disclosed, for example, in DE 35 19 058 A1 and DE 10 2006 045 483 A1.

It is the object of the present invention to specify a device which is improved relative to the prior art for electrically driving a longitudinal adjustment mechanism of a vehicle seat.

With regard to the mechanism for electrically driving a longitudinal adjustment mechanism of a vehicle seat, the object is achieved by the features disclosed in claim 1.

Advantageous developments of the invention form the subject matter of the sub-claims.

According to the invention, the device for electrically driving a longitudinal adjustment mechanism of a vehicle seat having two individual rails comprises a separate electrical drive means for each individual rail, wherein the electrical drive means in each case is configured as an electromechanically actuated planetary gear assembly. This permits a compact electrical drive of a longitudinal adjustment mechanism.

According to the invention, by the use of electromechanically actuated planetary gear assemblies as electrical drive means, a synchronous drive is permitted of both individual rails of the longitudinal adjustment mechanism without additional costly control and/or regulating measures, as a result of the control electronics required for operating the electromechanically actuated planetary gear assembly, said control electronics advantageously operating without separate sensors.

In this case, an individual planetary gear assembly comprising a plurality of individual planet gears arranged in series or a plurality of planetary gear assemblies with an individual planet gear as drive means may be provided for the two individual rails, wherein the planetary gear assembly (assemblies) synchronously drive the individual rails. Relative to conventional longitudinal adjustment mechanisms with a worm and spindle, the longitudinal adjustment mechanism according to the invention is configured without a spindle.

According to the invention, by means of the device according to the invention the weight of an electrically driven longitudinal adjustment mechanism of a vehicle seat is significantly reduced and the assembly thereof simplified in an advantageous manner.

Particularly advantageously, a rail spacing between the two individual rails in the vehicle is able to be adapted in a variable manner without having to alter a conventional motor bridge and/or the corresponding drive shafts. This increases the variability and permits the use of individual rails of the same construction in different vehicles.

Expediently, a constructional space, which is generally taken up below the vehicle seat by the motor bridge and the associated drive shafts and reduces the leg room for vehicle occupants sitting to the rear of the vehicle seat, is kept free so that the corresponding leg room is increased and the comfort of the vehicle occupants is increased. In an advantageous embodiment, constructional space for a drawer may be provided below the vehicle seat, for example.

By the elimination of the conventional longitudinal spindle there is a greater possibility for varying the choice of rail profiles so that, for example, more lightweight and/or narrower individual rails are permitted as a longitudinal spindle is not arranged inside the rail profile.

In an advantageous embodiment, the electrical drive means configured as an electromechanically actuated planetary gear assembly comprises a plurality of planet gears arranged in series. As a result, particularly high torques may be produced at relatively low rotational speeds. A drive unit formed from a planetary gear assembly with a plurality of planet gears is particularly compact and cost-effective. Such a planetary gear assembly is, for example, disclosed in the international patent application WO 2012/152727 A1 which is incorporated herein by way of reference.

In a first variant, the electromechanically actuated planetary gear assembly is arranged fixed on an outer rail of the respective individual rail of the longitudinal adjustment mechanism, wherein a toothed rod is arranged by a positive, material and/or non-positive connection and fixed at least partially on an inner rail of the respective individual rail of the longitudinal adjustment mechanism. Thus, during operation, the electromechanically actuated planetary gear assembly is fixedly coupled to a seat substructure and a vehicle structure, whereby the electrical contact is simplified.

In this case, the electromechanically actuated planetary gear assembly may be expediently arranged inside on the outer rail and may be held by means of at least one motor support in a reversible manner. As a result, the electromechanically actuated planetary gear assembly is arranged in a space-saving manner below a seat surface of the vehicle seat outside a direct field of vision.

Moreover, the electromechanically actuated planetary gear assembly may be arranged outside on the outer rail and may be at least partially reversibly arranged and held in a corresponding receiver opening which is formed in a base of the outer rail. As a result, even in the mounted state of the longitudinal adjustment mechanism, easy access to the electromechanically actuated planetary gear assembly is permitted.

In a second variant, the electromechanically actuated planetary gear assembly is arranged fixed on the inner rail of the respective individual rail of the longitudinal adjustment mechanism, wherein the toothed rod is arranged by a positive, material and/or non-positive connection and fixed at least partially on the outer rail of the respective individual rail of the longitudinal adjustment mechanism. Thus, during operation, the electromechanically actuated planetary gear assembly is fixedly coupled to the vehicle seat and when the seat is adjusted moves therewith relative to the seat substructure and vehicle structure.

In this case, the electromechanically actuated planetary gear assembly may advantageously be arranged inside on the inner rail and at least partially reversibly arranged and held in a corresponding receiver opening which is formed in the inner rail. As a result, the electromechanically actuated planetary gear assembly is arranged in a space-saving manner below a seat surface of the vehicle seat outside a direct field of vision.

The reversible arrangement of the electromechanically actuated planetary gear assembly on the respective individual rail permits a simple and uncomplicated replacement of a faulty electromechanically actuated planetary gear assembly.

In an advantageous embodiment, a groove is formed in the base of the outer rail, said groove being shaped so as to correspond to a spur gear of the electromechanically actuated planetary gear assembly, wherein the spur gear is at least partially arranged inside the groove, and the toothed rod and a counter holder are integrally formed or shaped on flanks of the groove.

In an alternative embodiment, at least one retaining portion is integrally formed or shaped on a lower end region of the inner rail, the electrical drive means at least partially bearing against or resting on said retaining portion, and wherein at least one further retaining portion is shaped or arranged on the base of the outer rail so as to be bent back, such that the toothed rod or the counter holder is arranged on this retaining portion.

Particularly preferably, a force is transmitted between the electrical drive means and individual rail by means of a spur gear arranged fixedly in terms of rotation on a drive shaft of the electromechanically actuated planetary gear assembly, said spur gear being configured so as to correspond with the toothed rod and engaging therein so as to mesh therewith.

Advantageously, the spur gear of the electromechanically actuated planetary gear assembly may be coupled to a further gear wheel which is engaged with a second toothed rod so as to mesh therewith. Thus greater torques are able to be transmitted. Moreover, the safety in the event of a crash is significantly improved by such an embodiment.

The invention is described in more detail with reference to the accompanying schematic figures.

In the drawings:

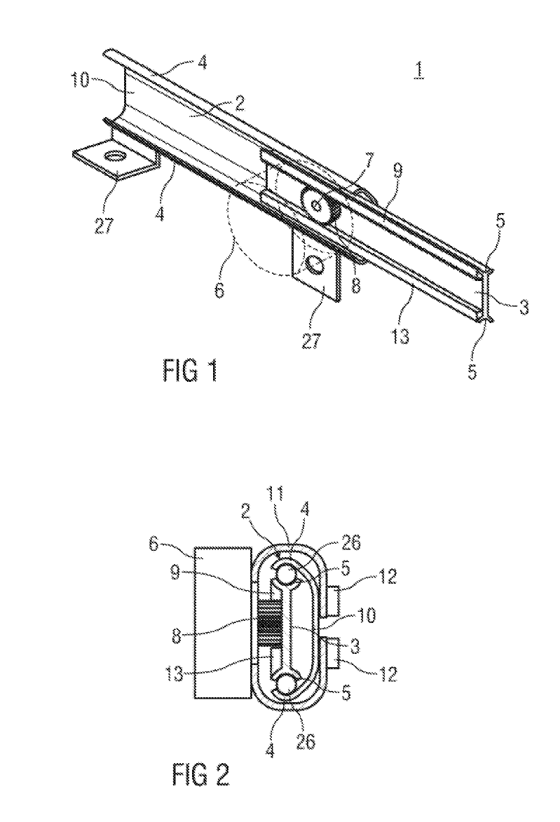

FIG. 1 shows schematically a perspective view of an electromotively movable individual rail of a rail system of a longitudinal adjustment mechanism of a vehicle seat in a first variant, wherein the electrical drive means is arranged on a vehicle body and the rail system consists of steel,

FIG. 2 shows schematically a sectional view of an electrically movable individual rail with an electrical drive means arranged inside on an outer rail, wherein the electrical drive means is arranged on a vehicle body and the rail system consists of steel,

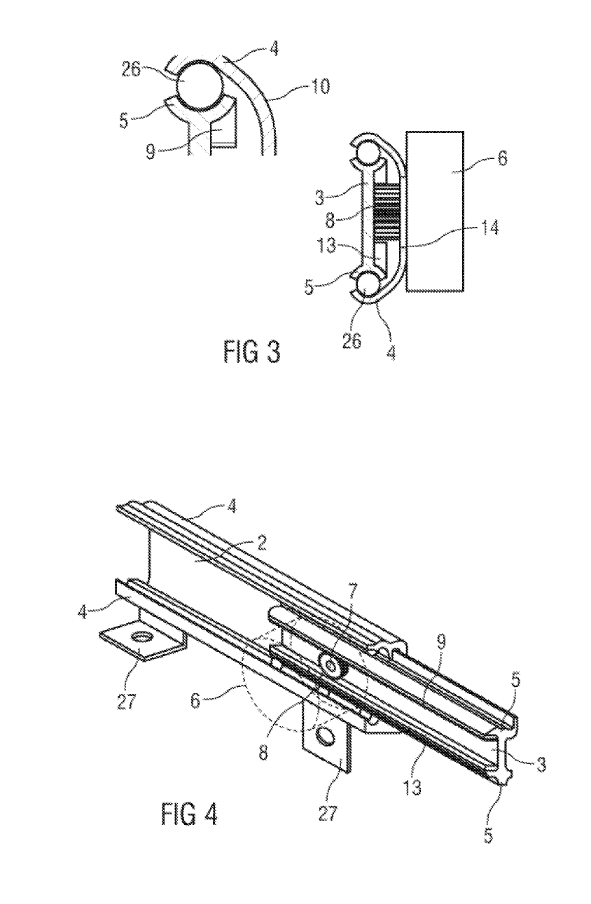

FIG. 3 shows schematically a sectional view of an electrically movable individual rail with an electrical drive means arranged outside on an outer rail, wherein the electrical drive means is arranged on a vehicle body and the rail system consists of steel,

FIG. 4 shows schematically a perspective view of an electromotively movable individual rail of a rail system of a longitudinal adjustment mechanism of a vehicle seat in a second variant, wherein the electrical drive means is arranged on a vehicle body and the rail system consists of aluminum,

FIG. 5 shows schematically a sectional view of an electrically movable individual rail with an electrical drive means arranged inside on an outer rail, wherein the electrical drive means is arranged on a vehicle body and the rail system consists of aluminum,

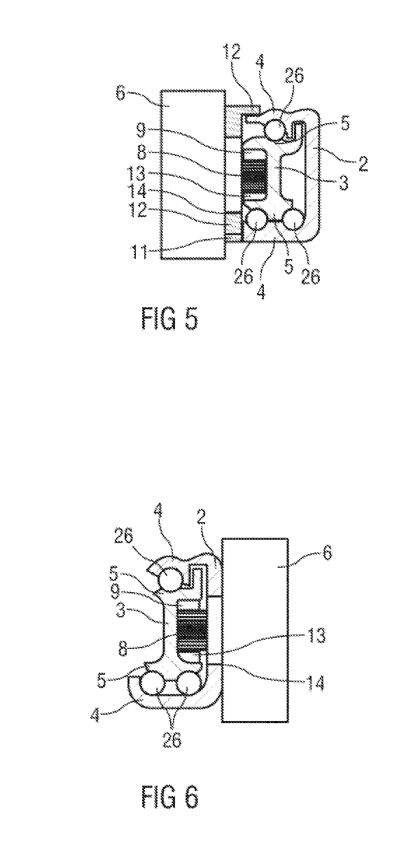

FIG. 6 shows schematically a sectional view of an electrically movable individual rail with an electrical drive means arranged outside on an outer rail, wherein the electrical drive means is arranged on a vehicle body and the rail system consists of aluminum,

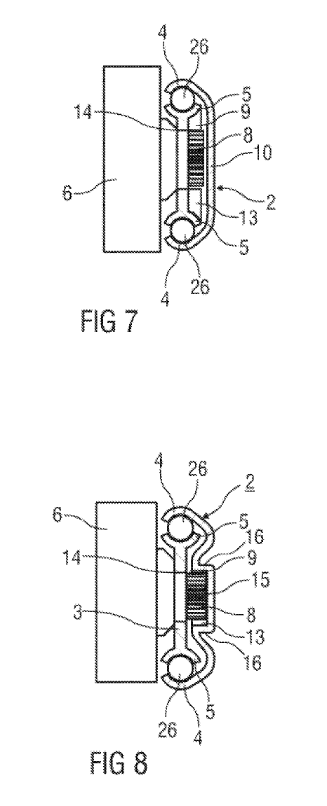

FIG. 7 shows schematically a sectional view of an electrically movable individual rail with an electrical drive means arranged inside on an inner rail in a first variant, wherein the electrical drive means is arranged on a vehicle seat and the rail system consists of steel,

FIG. 8 shows schematically a sectional view of an electrically movable individual rail with an electrical drive means arranged inside on an inner rail in a second variant, wherein the electrical drive means is arranged on a vehicle seat and the rail system consists of steel,

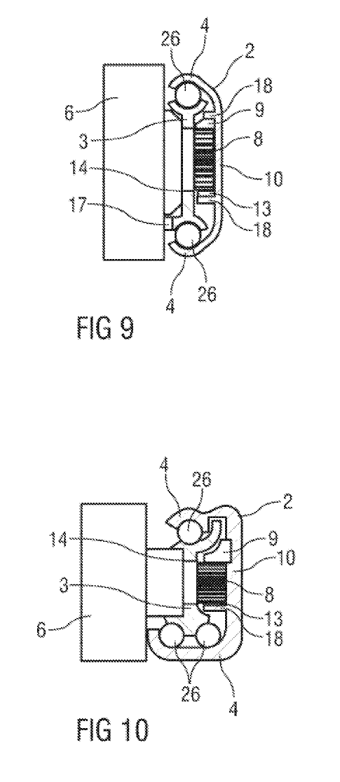

FIG. 9 shows schematically a sectional view of an electrically movable individual rail with an electrical drive means arranged inside on an inner rail in a third variant, wherein the electrical drive means is arranged on a vehicle seat and the rail system consists of steel,

FIG. 10 shows schematically a sectional view of an electrically movable individual rail according to FIG. 4 with an electrical drive means arranged inside on an inner rail in a first variant, wherein the electrical drive means is arranged on a vehicle seat and the rail system consists of aluminum,

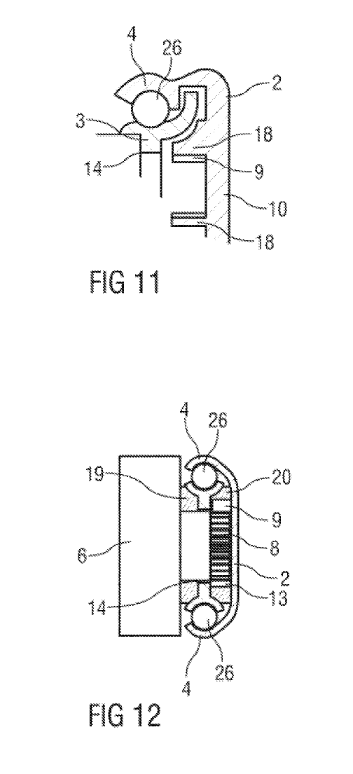

FIG. 11 shows schematically a sectional view of an electrically movable individual rail according to FIG. 4 with an electrical drive means arranged inside on an inner rail in a first variant, wherein the electrical drive means is arranged on a vehicle seat and the rail system consists of aluminum,

FIG. 12 shows schematically a sectional view of an electrically movable individual rail according to FIG. 1 with an electrical drive means arranged inside on an inner rail by means of a two-part motor support, wherein the electrical drive means is arranged on a vehicle seat and the rail system consists of steel,

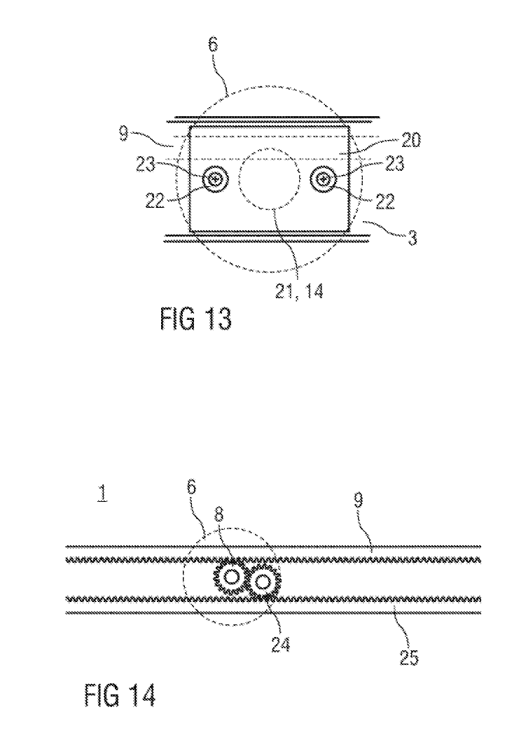

FIG. 13 shows schematically a side view of an electrically movable individual rail according to FIG. 1 with an electrical drive means arranged inside on an inner rail by means of a two-part motor support, wherein the electrical drive means is arranged on a vehicle seat and the rail system consists of steel and

FIG. 14 shows schematically a side view of a variant of an electrically movable individual rail with two spur gears and two toothed rods.

Parts which correspond to one another in all of the figures are provided with the same reference numerals.

FIG. 1 shows schematically a perspective view of an electromotively movable individual rail 1 of a rail system, not shown in more detail, in particular extending in a linear or curved manner, of a longitudinal adjustment mechanism of a vehicle seat in a first variant.

The individual rail 1 is part of a rail system for the seat adjustment of a vehicle seat in the longitudinal direction of the vehicle for positioning a vehicle occupant. Such a rail system is configured as a conventional rail system and comprises two individual rails 1 which are preferably arranged aligned in parallel with one another in the direction of travel on both sides in the vehicle and on the vehicle seat. In this case, each individual rail 1 comprises an outer rail 2 and an inner rail 3.

In this case conventional fastening means 27 may be arranged on the outer rail 2, said fastening means being configured, for example, as tabs and permitting a fastening of the individual rail 1 to a vehicle body.

The outer rail 2 and the inner rail 3 shown in FIG. 1 are manufactured from steel or a steel alloy.

In the operating position of the rail system the inner rail 3 is arranged and guided in a longitudinally displaceable manner at least partially in the outer rail 2.

The outer rail 2 in the conventional manner, not shown, is fastened to a vehicle floor of a vehicle and preferably aligned in the longitudinal direction of the vehicle.

A conventional vehicle seat is arranged on the inner rail 3. By a longitudinal displacement of the inner rail 3 relative to the outer rail 2, therefore, the vehicle seat is able to be longitudinally displaced in the vehicle.

In the embodiment according to FIG. 1, the outer rail 2 encompasses the inner rail 3 at the bottom and at the top. The outer rail 2 in this case has a profile cross section which is virtually c-shaped with two outer limbs 4.

The end regions 5 of the inner rail 3 arranged in the outer rail 2 are in each case shaped so as to correspond to the receiving rail profile, in particular the outer limbs 4, of the outer rail 2. In this case, the end regions 5 of the inner rail 3 preferably have a Y-shaped cross section.

For the guidance and displacement of the inner rail 3 relative to the outer rail 2 with minimal friction, conventional rolling bodies 26 are rotatably arranged between both rails 2, 3 at the top and at the bottom shown in FIG. 2. Preferably conventional steel balls or barrel-shaped rolling bodies are used as rolling bodies 26.

Said rolling bodies 26 roll between the respective outer limb 4 of the outer rail 2 and the end region 5 of the inner rail 3 and, as a result, permit a movement of the inner rail 3 relative to the outer rail 2 with minimal friction and reduced force.

According to the invention, each individual rail 1 of the longitudinal adjustment mechanism is assigned a separate electrical drive means 6. In this case, the electrical drive means 6 is configured as an electromechanically actuated planetary gear assembly, in particular as a tumble gear. In a preferred variant, such a planetary gear assembly may comprise a plurality of planet gears and produce particularly high torques at relatively low rotational speeds. A drive unit formed from a planetary gear assembly comprising a plurality of planet gears is particularly compact and cost-effective and is, for example, disclosed in the international patent application WO 2012/152727 A1.

In a first variant shown in FIG. 1, the electrical drive means 6 is arranged fixed on an outer rail 2 of the individual rail 1 of the longitudinal adjustment mechanism and thus during operation is fixedly coupled to a seat substructure and a vehicle structure.

A force is transmitted between the electrical drive means 6 and the individual rail 1 in this case by means of a spur gear 8 arranged on a drive shaft 7 of the electrical drive means 6, said spur gear acting on a toothed rod 9 arranged at least partially on the inner rail 3.

The toothed rod 9 and spur gear 8 are conventionally shaped so as to correspond to one another, in particular the corresponding toothing is of the same module. In this case, the toothed rod 9 and spur gear 8 are in engagement in the conventional manner so as to mesh with one another.

The toothed rod 9 is fixed, for example by a positive, material and/or non-positive connection, and arranged on the inner rail 3, in particular, in the region of one of the end regions 5.

By the use according to the invention of electromechanically actuated planetary gear assemblies as electrical drive means 6, a synchronous drive of both individual rails 1 of the longitudinal adjustment mechanism is permitted without additional costly measures, due to the control electronics required for the operation of the electromechanically actuated planetary gear assembly.

Particularly advantageously, a rail spacing between the two individual rails 1 in the vehicle may be adapted in a variable manner, without having to alter a motor bridge and/or the corresponding drive shafts. This increases the variability and permits the use of individual rails 1 in different vehicles.

By the elimination of the conventional longitudinal spindle, there is a greater possibility for varying the choice of rail profiles for the individual rail 1 so that, for example, more lightweight and/or narrower individual rails 1 are permitted.

FIG. 2 shows schematically a sectional view of an electrically movable individual rail 1 according to FIG. 1 with the electrical drive means 6 arranged inside on the outer rail 2. In this case, the open side of the c-shaped profile of the outer rail 2 remote from a base 10 is denoted as the inside of the outer rail 2.

In this embodiment, the electrical drive means 6 is retained in the conventional manner on a motor support 11. The motor support 11 in this case is configured to encompass the individual rail 1 at the top and/or at the bottom and is reversibly held on the base 10 of the outer rail 2 by means of at least one, preferably two, conventional fastening means 12, for example screws.

In an alternative embodiment, not shown, the motor support 11 may be arranged by a material connection on the outer rail 2 and the electrical drive means 6 is reversibly fastened to the motor support 11 in the conventional manner.

Preferably a counter holder 13 is arranged at the end region 5 of the inner rail 3 with the end region 5 opposing the toothed rod 9, said counter holder acting on the spur gear 8 on the side opposing the toothed rod 9 and preventing the spur gear 8 from being lifted from the toothed rod 9.

As a result, the spur gear 8 and a toothed rod 9 are in positive engagement, even in the case of very high forces acting thereon, for example in the case of a crash, and thus prevent a movement of the individual rail 1 and a movement of the vehicle seat relative to the vehicle body.

In a particularly advantageous embodiment, not shown in more detail, a surface of the counter holder 13 facing in the direction of the spur gear 8 is provided with a sliding layer which reduces the wear of the counter holder 13.

FIG. 3 shows schematically a sectional view of an electrically movable individual rail 1 according to FIG. 1 with the electrical drive means 6 arranged outside on the outer rail 2. In this case, the base 10 is denoted as the outside of the outer rail 2.

This variant corresponds substantially to the variant of FIG. 2 with the difference that the electrical drive means 6 is at least partially arranged and held in a corresponding receiver opening 14 which is formed in the base 10 of the outer rail 2.

FIG. 4 shows schematically a perspective view of an electrically movable individual rail 1 of a rail system, not shown in more detail, of a longitudinal adjustment mechanism of a vehicle seat in a first variant.

This variant corresponds substantially to the variant according to FIG. 1 with the difference that the outer rail 2 and inner rail 3 are manufactured from a lightweight metal, for example aluminum or an aluminum alloy or magnesium or a magnesium alloy and are shaped according to the requirements of this material. In this case, in particular the outer limbs 4 of the outer rail and the end regions 5 of the inner rail 3 are correspondingly reinforced.

The outer rail 2 and inner rail 3 are in this case preferably produced in an extrusion process.

For example, for minimizing the surface pressure and the wear resulting therefrom, two rows of rolling bodies 26 adjacent to one another are arranged on the lower face of the inner rail 3.

FIG. 5 shows schematically a sectional view of an electrically movable individual rail 1 according to FIG. 4 with the electrical drive means 6 arranged inside on the outer rail 2. This variant corresponds substantially to the variant according to FIG. 2 with the difference that the motor support 11 on the front face and/or upper face is held by means of conventional fastening means 12 on the outer rail.

In an alternative embodiment, not shown, the motor support 11 may be arranged by a material connection on the outer rail 2 and the electrical drive means 6 is reversibly fastened to the motor support 11 in the conventional manner.

FIG. 6 shows schematically a sectional view of an electrically movable individual rail 1 according to FIG. 4 with the electrical drive means 6 arranged outside on the outer rail 2.

This variant corresponds substantially to the variant according to FIG. 5 with the difference that the electrical drive means 6 is at least partially arranged and held in a corresponding receiver opening 14 which is formed in the base 10 of the outer rail 2.

In a second variant, the electrical drive means 6 is arranged fixed on the inner rail 3 of the individual rail 1 of the longitudinal adjustment mechanism, and thus during operation is fixedly coupled to the vehicle seat and when the seat is adjusted moves therewith relative to the seat substructure and vehicle structure.

A force is transmitted between the electrical drive means 6 and the individual rail 1 in this case by means of the spur gear 8 arranged on the drive shaft 7 of the electrical drive means 6, said spur gear acting on a toothed rod 9 arranged at least partially on the outer rail 2.

The toothed rod 9 and spur gear 8 are formed in the conventional manner so as to correspond with one another, in particular the corresponding toothing is of the same module.

The toothed rod 9 is arranged fixed on the outer rail 2, for example by a positive, material and/or non-positive connection.

FIG. 7 shows schematically a sectional view of the electrically movable individual rail 1 according to FIG. 1 with an electrical drive means 6 arranged inside on the inner rail 3, in a first variant. In this case, the side of the inner rail 3 remote from the base 10 of the outer rail 2 is denoted as the inside of the inner rail 3.

The electrical drive means 6 is arranged and held at least partially in a corresponding receiver opening 14 which is formed in the inner rail 3, for example as a through-hole.

The spur gear 8 in this case is arranged such that it is in engagement with the toothed rod 9 so as to mesh therewith. The toothed rod 9 and counter holder 13 are configured in this variant as separate components and fastened to the substantially planar base 10 of the outer rail 2 by being fixed to the frame by a positive, material and/or non-positive connection.

FIG. 8 shows schematically a sectional view of the electrically movable individual rail 1 according to FIG. 1 with an electrical drive means 6 arranged inside on the inner rail 3, in a second variant.

This variant corresponds substantially to the variant according to FIG. 7 with the difference that a groove 15 is formed in the base 10 of the outer rail 2, said groove being shaped so as to correspond to the spur gear 8. The spur gear 8 is arranged in this case at least partially inside the groove 15.

Accordingly, the toothed rod 9 and the counter holder 13 are integrally formed or shaped on the flanks 16 of the groove 15. This integral forming or shaping may take place in one piece in a preferred variant.

FIG. 9 shows schematically a sectional view of the electrically movable individual rail 1 according to FIG. 1 with an electrical drive means 6 arranged inside on the inner rail 3, in a third variant.

This variant corresponds substantially to the variant according to FIG. 7 with the difference that a retaining portion 17 is integrally formed or shaped on the lower end region 5 of the inner rail 3, the electrical drive means 6 at least partially bearing against or resting on said retaining portion.

Moreover, on the base 10 of the outer rail 2 two further retaining portions 18 are shaped or arranged so as to be bent back such that the toothed rod 9 is arranged on one of these retaining portions 18, whilst the counter holder 13 is arranged on the other retaining portion 18.

FIG. 10 shows schematically a sectional view of the electrically movable individual rail 1 according to FIG. 4, with an electrical drive means 6 arranged inside on the inner rail 3, in a first variant. In this case, the side of the inner rail 3 remote from the base 10 of the outer rail 2 is denoted as the inside of the inner rail 3.

The electrical drive means 6 is at least partially arranged and held in a corresponding receiver opening 14 which is formed in the inner rail 3, for example as a through-hole.

In this case, the receiver opening 14 may be widened in a step-like manner toward the piezoelectric actuator drive 6.

The spur gear 8 in this case is arranged such that it is in engagement with the toothed rod 9 so as to mesh therewith. The toothed rod 9 and the counter holder 13 in this variant are configured as separate components and fastened to the substantially planar base 10 of the outer rail 2 by being fixed by a positive, material and/or non-positive connection.

In this case, a retaining portion 18 is shaped or arranged on the base 10 of the outer rail 2 so as to be bent back such that the counter holder 13 is arranged on this retaining portion 18.

FIG. 11 shows schematically a sectional view of the electrically movable individual rail 1 according to FIG. 4 with an electrical drive means 6 arranged inside on the inner rail 3, in a second variant.

This variant corresponds substantially to the variant according to FIG. 10 with the difference that two further retaining portions 18 are shaped or arranged on the base 10 of the outer rail 2 so as to be bent back, such that the toothed rod 9 is arranged on one of these retaining portions 18 whilst the counter holder 13 is arranged on the other retaining portion 18.

FIG. 12 shows schematically a sectional view of the electrically movable individual rail 1 according to FIG. 1 with an electrical drive means 6 arranged inside on the inner rail 3 by means of a two-part motor support 11.

Such a two-part motor support 11 comprises a first individual part 19 and a second individual part 20. In this case, the first individual part 19 is arranged inside on the inner rail 3 and the second individual part 20 is arranged on the opposing side. The inner rail 3 is thus partially enclosed by the individual parts 19, 20 of the two-part motor support 11.

In the individual parts 19, 20 of the two-part motor support 11 in each case a receiver opening 21 is formed as a through-opening or through-bore, wherein these receiver openings 21 are configured so as to correspond to the receiver opening 14 in the inner rail 3 and the portion of the electrical drive means 6 to be received.

For arranging the electrical drive means 6, the receiver openings 21 of the individual parts 19, 20 and the receiver opening 14 of the inner rail 3 are arranged in a congruent manner.

FIG. 13 shows schematically a side view of the electrically movable individual rail 1 according to FIG. 1 with an electrical drive means 6 arranged inside on the inner rail 3 by means of a two-part motor support 11.

On both sides of the receiver openings 14, 21 in each case a fastening portion 22 is formed, for example as a threaded bore, in the corresponding components in the longitudinal direction of the inner rail 3. During the mounting of the piezoelectric actuator drive on the inner rail 3, conventional fastening means 23, for example screws, are arranged in the fastening portions 22 and in this manner connect together the individual parts 19, 20 of the two part motor support 11, the inner rail 3 and the electrical drive means 6.

The individual part 20 preferably has a groove for guiding the toothed rod 9.

FIG. 14 shows schematically a side view of a variant of an electrically movable individual rail 1 with two spur gears 8, 24 and two toothed rods 9, 25.

In this advantageous embodiment, the spur gear 8 of the electrical drive means 6 is coupled to a further spur gear 24 which acts on a second toothed rod 25 which is arranged at the location of the counter holder 13 on the individual rail 1 so that greater torques may be transmitted in this manner.

The spur gears 8, 24 are configured so as to correspond to one another and are in engagement so as to mesh with one another, so that a rotational movement of the electrical drive means 6 is transmitted from the spur gear 8 to the spur gear 24.

In this case, the spur gear 8 is in engagement with the toothed rod 9 and the spur gear 24 is in engagement with the second toothed rod 25 so as to mesh with one another. In this case, the toothed rod 9 and the toothed rod 25 are arranged together on the same component of the individual rail 1 and move in the same direction.

### LIST OF REFERENCE NUMERALS

1 Individual rail
2 Outer rail
3 Inner rail
4 Outer limb
5 End region
6 Electrical drive means
7 Drive shaft
8 Spur gear
9 Toothed rod
10 Base
11 Motor support
12 Fastening means
13 Counter holder
14 Receiver opening
15 Groove
16 Flank
17 Retaining portion
18 Further retaining portion
19 First individual part
20 Second individual part
21 Receiver opening
22 Fastening portion
23 Fastening means
24 Further spur gear
25 Toothed rod
26 Rolling body

1. A device for electrically driving a longitudinal adjustment mechanism of a vehicle seat having two individual rails comprising:
a separate electrical drive device for each individual rail,
wherein the electrical drive device is configured as an electromechanically actuated planetary gear assembly comprising a plurality of planet gears arranged in series, which permits a synchronous drive of both individual rails.

2. The device as claimed in claim 1, wherein the electromechanically actuated planetary gear assembly is arranged fixed on an outer rail of the respective individual rail of the longitudinal adjustment mechanism, wherein a toothed rod is arranged by a positive, material and/or non-positive connection and fixed at least partially on an inner rail of the respective individual rail of the longitudinal adjustment mechanism.

3. The device as claimed in claim 2, wherein the electromechanically actuated planetary gear assembly is arranged inside on the outer rail and is held by at least one motor holder in a reversible manner.

4. The device as claimed in claim 2, wherein the electromechanically actuated planetary gear assembly is arranged outside on the outer rail and is at least partially reversibly arranged and held in a corresponding receiver opening which is formed in a base of the outer rail.

5. The device as claimed in claim 1, wherein the electromechanically actuated planetary gear assembly is arranged fixed on the inner rail of the respective individual rail of the longitudinal adjustment mechanism, wherein the toothed rod is arranged by a positive, material and/or non-positive connection and fixed at least partially on the outer rail of the respective individual rail of the longitudinal adjustment mechanism.

6. The device as claimed in claim 5, wherein the electromechanically actuated planetary gear assembly is arranged inside on the inner rail and at least partially reversibly arranged and held in a corresponding receiver opening which is formed in the inner rail.

7. The device as claimed in claim 5, wherein a groove is formed in the base of the outer rail, said groove being shaped so as to correspond to a spur gear of the electromechanically actuated planetary gear assembly, wherein the spur gear is at least partially arranged inside the groove and the toothed rod and a counter holder are integrally formed or shaped on flanks of the groove, or that at least one retaining portion is integrally formed or shaped on a lower end region of the inner rail, the electrical drive device at least partially bearing against or resting on said retaining portion and wherein at least one further retaining portion is shaped or arranged on the base of the outer rail so as to be bent back, such that the toothed rod or the counter holder is arranged on this retaining portion.

8. The device as claimed in claim 1, wherein a force is transmitted between electrical drive device and the individual rail by a spur gear arranged fixedly in terms of rotation on a drive shaft of the electromechanically actuated planetary gear assembly, said spur gear being configured so as to correspond to the toothed rod and engaging therein so as to mesh therewith.

9. The device as claimed in claim 8, wherein the spur gear of the electromechanically actuated planetary gear assembly is coupled to a further gear wheel, which is engaged with a second toothed rod so as to mesh therewith.
